(19) United States
(12) Patent Application Publication
(10) Pub. No.: US 2008/0126123 A1
(43) Pub. Date: May 29, 2008

(54) CUSTOMIZING HEALTHCARE INFORMATION

(75) Inventor: David Wayne Duckert, Menomonee Falls, WI (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/564,505

(22) Filed: Nov. 29, 2006

(51) Int. Cl. G06Q 50/00

(52) U.S. Cl. 705/2

(57) ABSTRACT

Customized healthcare information is provided to a user based, at least in part, on the user's healthcare literacy. More specifically, customized healthcare information is provided to the user by determining the user's healthcare literacy, selecting healthcare information from one or more data stores based, at least in part, on the user's healthcare literacy, and providing the healthcare information to the user from the data stores. The user's healthcare literacy can be determined by administering a healthcare literacy test to the user. The healthcare information provided to the user can also be based, at least in part, on additional data about the user, which can be received from a monitoring device, include at least one or more of psychological or physiological data about the user, and be received from the user. Systems, methods, machine-readable storage medium, and machine-executable code are also disclosed, as is customizing other subject matter information based on the user's subject matter literacy.

### FIELD OF INVENTION

In general, the inventive arrangements relate to healthcare, and more specifically, to providing customized healthcare information to users based, at least in part, on the users' healthcare literacy.

### BACKGROUND OF INVENTION

For illustrative, exemplary, representative, and non-limiting purposes, various embodiments of the inventive arrangements will be described in terms of healthcare. However, the inventive arrangements are not limited in this regard.

In many healthcare applications, it can be desirable to assess a patient's healthcare literacy before attempting to communicate with them. For example, in many face-to-face meetings between doctors and patients, doctors can intuitively determine patient comprehension based on facial expressions, body language, question and answer exchanges, etc. In the future, however, increasing amounts of healthcare, and healthcare information, will be delivered to patients remotely. These patients may be, for example, at home or work, on vacation, traveling, in an institution, etc., such that they are remote from a traditional caregiver and/or point of care. Accordingly, it will continue to be increasingly difficult to accurately assess healthcare literacy when patients are remotely situated from information providers, yet still need healthcare information.

In addition, a growing trend towards self-monitoring and remote-monitoring of patient healthcare continues to expand rapidly. This monitoring can take a variety of different forms, including, for example, providing a monitoring device in a home or workplace, a portable monitoring device, a portable device with monitoring capabilities (e.g., a cellular telephone, personal digital assistant (“PDA”), and/or the like), a user kiosk, a personal or networked computer, a web portal, a telephone-based interactive voice response (“IVR”) system, etc. In the healthcare embodiment, for example, such monitoring devices can capture psychological and/or physiological data about users, such as at least one or more of their electrocardiograph (“ECG”) data, blood oxygen saturation data, respiration data, blood glucose data, blood pressure data, lung function data, SpO₂ saturation data, temperature data, weight data, fat analysis data, heart rate data, patient activity data, symptoms, and/or overall health data (e.g., using a self-assessment SF-36 Questionnaire, which can be used to gauge a user's overall health), etc. However, since much of this monitoring can also be remote from the traditional caregiver and/or point of care, it will continue to be increasingly difficult to accurately assess healthcare literacy when patients are remotely situated from information providers, yet still need healthcare information.

In the above contexts, healthcare information broadly covers information such as coaching, instructional, and/or educational materials, as well as treatment regimens, medication instructions, self-assessment questionnaires, dietary and exercise advice, diagnostic and/or prognostic information, medical procedure results, laboratory test results, pharmaceutical and/or prescription information, medical coverage information, disease and/or condition information, including type and severity, etc., and it can be delivered to remote patients through a variety of different forms, such as paper mailings, the afore-mentioned monitoring devices, user kiosks, personal or networked computers, web portals, telephones, PDAs, and/or the like.

Unfortunately, however, levels of healthcare literacy can vary drastically from patient to patient. For example, some patients may be medically savvy and easily understand healthcare terminology, while others may not be as well-versed and/or able to understand healthcare terminology—e.g., some patients may know that “cardiac” refers to the heart, while other patients may not; some patients may know that a low sodium diet means a diet with little salt, while other patients may not; and some patients may know that “hypertension” refers to high blood pressure, while other patients may not.

In addition, some patients, due to age or severity of disease, disability, and/or the like, may prefer one form of communication over another. For example, various patients may suffer from hearing loss, reduced vision, and/or reduced manual dexterity, as well as cognitive impairments, thereby effecting their healthcare literacy.

However, unless healthcare information is tailored to individual patients, it can be easy to misinterpret and/or misunderstand, and these misunderstandings can jeopardize patient health.

One unsatisfactory solution has been to provide healthcare information to patients in a very basic and/or rudimentary format, reducing deliverable content to a lowest common audience. Needless to say, however, such an approach does not appeal to patients who are more literate in healthcare and healthcare terminology.

In accordance with the foregoing, current arrangements for assessing patients' healthcare literacy and customizing healthcare information accordingly, particularly when such patients are remote from traditional caregivers and/or points of care, have not been satisfactory. Thus, it remains desirable to provide customized healthcare information to patients based on their own personal healthcare literacy levels, thereby enhancing healthcare communications.

Accordingly, it is desirable to tailor healthcare information and/or other subject matter information to particular persons and/or audiences based on their comfort and/or knowledge levels and/or understandings of particular healthcare information and/or other subject matters information.

### SUMMARY OF INVENTION

In one embodiment, a system for providing healthcare information comprises a user interface configurable to interact with a user; a processor configurable to interact with the user through the user interface to determine the user's healthcare literacy; and a memory configurable to contain one or more data stores for providing healthcare information to the user from the data stores based, at least in part, on the user's healthcare literacy.

In another embodiment, a method for providing healthcare information comprises determining a user's healthcare literacy; selecting healthcare information from one or more data stores based, at least in part, on the user's healthcare literacy; and providing the healthcare information to the user from the data stores.

In yet another embodiment, a machine-readable storage medium contains machine-executable code for instructing a system to determine a user's healthcare literacy; select healthcare information from one or more data stores based, at least in part, on the user's healthcare literacy; and provide the healthcare information to the user from the data stores.

And in yet still another embodiment, machine-executable code stored on a machine-readable storage medium comprises code for determining a user's healthcare literacy; code for selecting healthcare information from one or more data stores based, at least in part, on the user's healthcare literacy; and code for providing the healthcare information to the user from the data stores.

In a further embodiment, a system for providing subject matter information comprises a user interface configurable to interact with a user; a processor configurable to interact with the user through the user interface to determine the user's subject matter literacy; and a memory configurable to contain one or more data stores for providing subject matter information to the user from the data stores based, at least in part, on the user's subject matter literacy.

In another further embodiment, a method for providing subject matter information comprises determining a user's subject matter literacy; selecting subject matter information from one or more data stores based, at least in part, on the user's subject matter literacy; and providing the subject matter information to the user from the data stores.

In yet another further embodiment, a machine-readable storage medium contains machine-executable code for instructing a system to determine a user's subject matter literacy; select subject matter information from one or more data stores based, at least in part, on the user's subject matter literacy; and provide the subject matter information to the user from the data stores.

And in yet still another further embodiment, machine-executable code stored on a machine-readable storage medium comprises code for determining a user's subject matter literacy; code for selecting subject matter information from one or more data stores based, at least in part, on the user's subject matter literacy; and code for providing the subject matter information to the user from the data stores.

### BRIEF DESCRIPTION OF SEVERAL VIEWS OF THE DRAWINGS

A clear conception of the advantages and features constituting inventive arrangements, and of various construction and operational aspects of typical mechanisms provided by such arrangements, are readily apparent by referring to the following illustrative, exemplary, representative, and non-limiting figures, which form an integral part of this specification, in which like numerals generally designate the same elements in the several views, and in which:

FIG. 1 is a schematic diagram of a system for providing subject matter information and/or healthcare information in accordance with an embodiment of the inventive arrangements;

FIG. 2 is a tabular depiction of providing healthcare information from various data stores according to various healthcare literacy levels; and

FIG. 3 is a flowchart of a method for providing subject matter information and/or healthcare information in accordance with an embodiment of the inventive arrangements.

### DETAILED DESCRIPTION OF VARIOUS PREFERRED EMBODIMENTS

For illustrative, exemplary, representative, and non-limiting purposes, various embodiments of the inventive arrangements will be described in terms of healthcare. However, the inventive arrangements are not limited in this regard. For example, while various embodiments provide customized healthcare information to users based, at least in part, on the users' healthcare literacy, other subject matter contexts are also hereby contemplated, including libraries, shops, banks, games, and/or the like. For example, if a person is looking for a book on a specific subject, the person's general knowledge of that subject matter could be determined before various books are recommended. Similarly, a person's general awareness of a problem solved by a new product or drawbacks of existing similar products, etc. could be determined before describing features of that new product to that person.

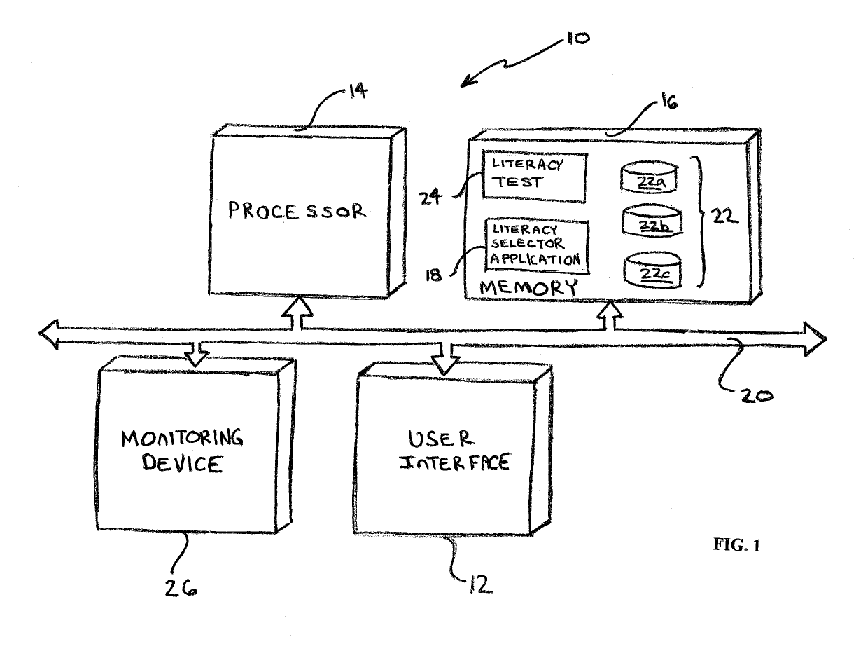

Referring now to FIG. 1, a schematic diagram of a system 10 for providing information in accordance with an embodiment of the inventive arrangements is shown, comprising a user interface 12, processor 14, and memory 16.

More specifically, the user interface 12 is configurable to interact with a user (not shown) and may contain, for example, one or more functional input devices (not shown), such as a keyboard and/or mouse, keypad, thumbwheel, stylus-driven window applications, touch-screens, etc., and/or one or more functional output devices (not shown), such a screen, monitor, printer, etc. The input devices and output devices may be separate or integrated components of the system 10 and/or user interface 12, as needed and/or desired.

Typically, the system 10 comprises both volatile memory, such as Random Access Memory (“RAM”) (not shown), and non-volatile memory 16, such as Read Only Memory (“ROM”), the latter of which can be stored on a hard-disk drive or other fixed-storage memory device and/or the like. As such, the non-volatile memory 16 commonly stores therein an operating system (not shown) and one or more application programs, such as the Literacy Selector Application (“LSA”) 18 of the inventive arrangements. Alternatively, one or more application programs, including the LSA 18, may also be stored in a removable memory device, such as, for example, a floppy disk or optical disk for use with a CD-ROM, on a web-server, and so forth.

In any event, the processor 14 and memory 16 can be any suitable devices known to those skilled in the art, wherein, for example, the operating system is conventionally loaded from the non-volatile memory 16 into the volatile memory during bootstrapping of the system 10 and then executed. Subsequently, the operating system then loads the LSA 18 from the non-volatile memory 16 into the volatile memory for similar execution. Upon the loading thereof, for example, the processor 14 can then execute the LSA 18 and other application programs. More specifically, the processor 14 can execute one or more programmed code sections of the LSA 18 in order to perform various operations, including the operations of the inventive arrangements. Each programmed code section thus includes instructions that can be executed by the processor 14. As such, the inventive arrangements of the LSA 18 can be carried out.

Alternatively, one skilled in the art will recognize that the inventive arrangements can also be realized in hardware, software, firmware, or other various combinations thereof. A representative visualization tool according to the inventive arrangements can be realized in a centralized fashion over one integrated system 10, or alternatively, in a distributed fashion in which multiple elements and components are spread over multiple, interconnected systems 10′. Moreover, any kind of system 10, or other apparatus, adapted for carrying out the inventive methods described herein is suited. For example, a typical combination of hardware and software could be a general purpose computer system 10″ with a computer program that, upon loading and execution, controls the computer system 10″ such that the inventive methods described herein can be carried out. The inventive arrangements can also be embedded in a computer program product comprising the features of an enabling implementation of the inventive methods as described herein, and which, upon being loaded and executed by the computer system 10″, can thus carry out the inventive methods.

In the context of this description, application programs, computer programs, and the like, include any expression, in any language, code, or notation, of a set of instructions intended to cause a system 10, or the like, having an information processing capability, to perform particular functions either i) directly, or ii) after either or both of the following occur: a) conversion to another language, code, or notation; or b) reproduction in a different material form. For example, the LSA 18 can be written in any suitable programming language to provide the desired functionality.

In any event, in operation of the preferred embodiment shown in FIG. 1, the user interface 12, processor 14, and memory 16 can communicate through a conventional network 20, the components of which may communicate therewith in wired or wireless fashions, as needed and/or desired, and the memory 16 comprises one or more data stores 22, which structure data in relation to various literacy levels, as will be elaborated upon.

In the figure, the processor 14 interacts with the user through the user interface 12 to determine the user's subject matter literacy. Referring generally, subject matter literacy is a relative measure of the degree to which users have the ability to process and understand subject matter information, often making decisions and/or taking actions based thereon. With awareness of a user's subject matter literacy, appropriate subject matter information can be customized and conveyed to the user, and one way to gauge the user's subject matter literacy is to administer a literacy test 24, such as a subject matter literacy test stored in the memory 16 of the system 10.

Referring now more specifically to healthcare, for example, the processor 14 can interact with the user through the user interface 12 to determine the user's healthcare literacy. Referring generally, healthcare literacy is a relative measure of the degree to which users have the ability to process and understand healthcare information, often making decisions and/or taking actions based thereon. With awareness of a user's healthcare literacy, appropriate healthcare information can be customized and conveyed to the user, and one way to gauge the user's healthcare literacy is to administer a literacy test, such as a healthcare literacy test stored in the memory 16 of the system 10.

More specifically, although healthcare literacy is a complex and multi-faceted notion, various tests have been developed and can be used to accurately assess a user's healthcare literacy. For example, the Test of Functional Health Literacy in Adults (“TOFHLA”) and/or Rapid Estimate of Adult Literacy in Medicine (“REALM”) can be used to accurately determine a user's healthcare literacy. Such healthcare literacy tests can be administered by providing at least one of a paper document, tablet input, user kiosk, interactive telephonic connection, computer session, and/or computer internet connections to the user. They can be used to assess a user's general familiarity with healthcare and/or medical terminology, treatments, language skills, general knowledge, comprehension abilities, disabilities, and/or the like.

Once the user's healthcare literacy is known, then appropriate material relative to the user's healthcare literacy can be provided. For example, the memory 16 in FIG. 1 contains one or more data stores 22 (e.g., 22a, 22b, 22c, . . . ), which can structure data in relation to various literacy levels. For example, a first data store 22a can contain lower literacy subject matter information and/or healthcare information, written for a lower literacy audience, while a second data store 22b can contain medium literacy subject matter information and/or healthcare information, written for a medium literacy audience, and a third data store 22c can contain higher literacy subject matter information and/or healthcare information, written for a higher literacy audience. Then, based, at least in part, on the user's healthcare literacy, information from the appropriate data store 22 can be provided to the user.

In various preferred embodiments, the data stores 22 can be implement as a single database or multiple databases, as needed and/or desired. In addition, the processor 14 can control the LSA 18 to select the proper data store 22 based on the results of the literacy test 24. For example, the processor 14 can use an algorithm to score the results of the literacy test 24 and select the appropriate data store 22 to use to present the subject matter information and/or healthcare information to the user based thereon the results of the literacy test 24.

In various preferred embodiments, the literacy test 24 can also be generated using adaptive testing techniques to select the test questions, which can also be static or dynamic over time, and the processor 14 can administer the literacy test 24 using the user interface 12, as needed and/or desired. It can also be administer in desired languages, as needed and/or desired, which the user may select from the user interface 12 in at least one preferred embodiment. The literacy test 24 can also test the user's general healthcare literacy or the user's healthcare literacy as related to a specific disease and/or the like, such as diabetes for example. In various preferred embodiments, the user may also be able to select a desired literacy level, as needed and/or desired, either with or without the literacy test 24.

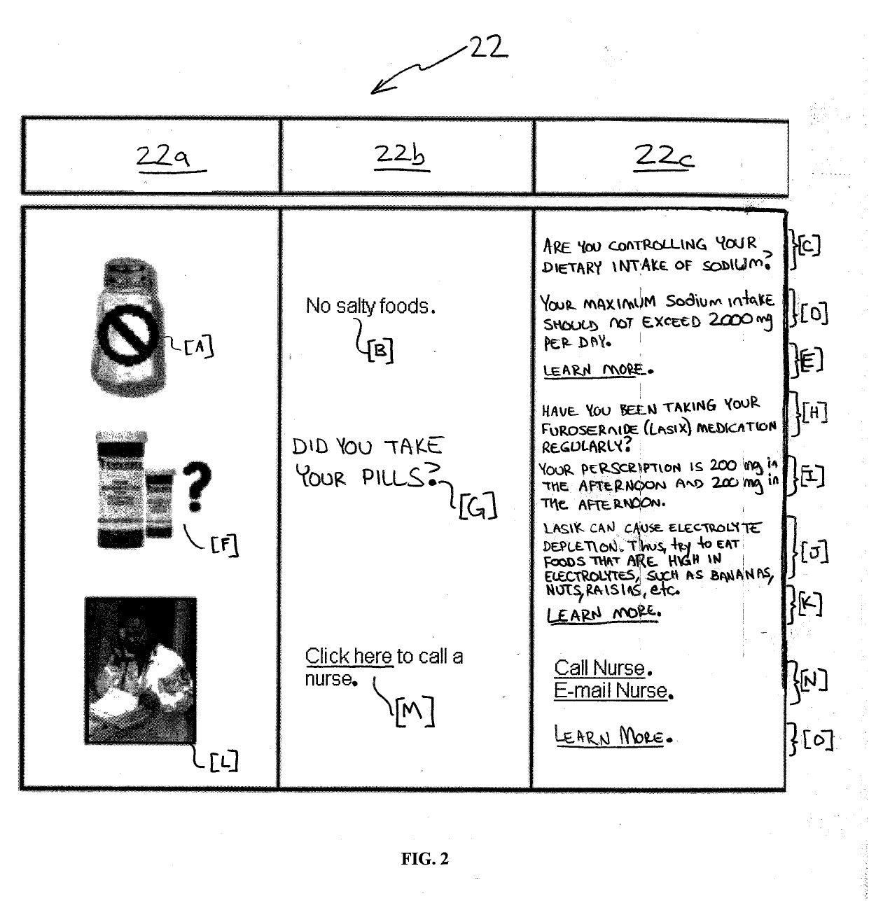

Referring now to FIG. 2, for example, information from the first data store 22a may convey an iconic picture depicting no salt [A]; and similar information from the second data store 22b may convey the words “No Salt” or “No Salty Foods” (written in an appropriate language) [B]; and similar information from the third data store 22c may convey the query “Are you controlling your dietary intake of sodium?” [C], as well as additional information such as “Your maximum sodium intake should not exceed 2000 mg per day” [D] and/or an option (e.g., a hyperlink) to “Learn More” (again, written in an appropriate language) [E]. Accordingly, a proper level of detail can be provided to the user based on the user's healthcare literacy, whereby information in appropriate levels of detail and sophistication can be scaled to match the user's own personal healthcare literacy.

Likewise, other representative information from the first data store 22a could convey an iconic picture asking a user if the user took their pills [F]; and similar information from the second data store 22b could convey the query “Did you take your pills?” [G]; and similar information from the third data store 22c could convey the query “Have you been taking your Furosernide (Lasix) medication regularly?” [H], as well as additional information such as “Your Prescription is 200 mg in the morning and 200 mg in the afternoon” [I] and/or “Lasix can cause electrolyte depletion. Thus, try to eat foods that are high in electrolytes, such as bananas, nuts, raisins, etc.” [J] and/or an option (e.g., a hyperlink) to “Learn More” [K].

Likewise, other representative information from the first data store 22a could convey an iconic picture reminding a user to call a nurse [L]; and similar information from the second data store 22b could convey a hyperlink to call the nurse [M]; and similar information from the third data store 22c could convey a hyperlink to call or e-mail the nurse [N] and/or an option (e.g., a hyperlink) to “Learn More” [O].

Accordingly, a proper level of detail can be provided to a user based on the user's healthcare literacy, whereby information in appropriate levels of detail and sophistication can be scaled to match the user's own personal healthcare literacy.

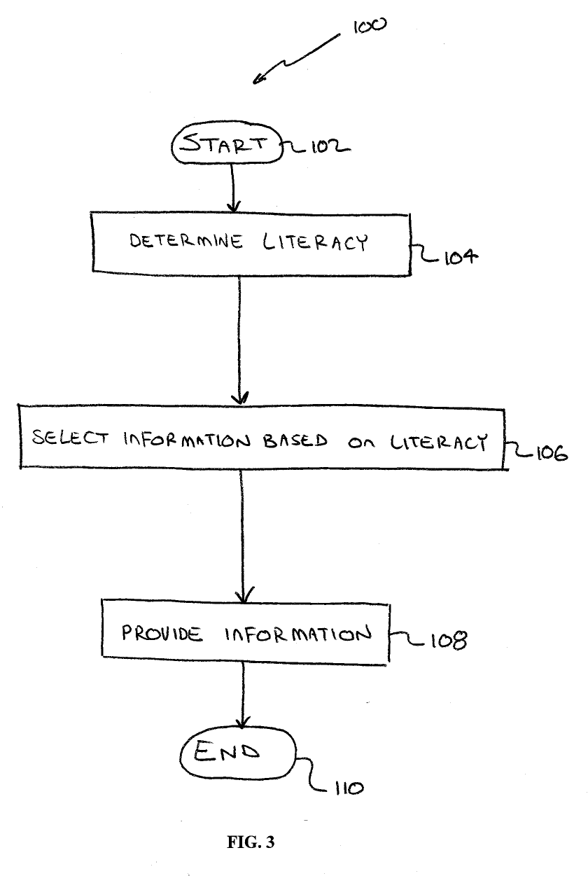

Referring now to FIG. 3, a method 100 begins in a step 102, after which control then passes to a step 104 to determine the user's subject matter literacy and/or healthcare literacy, after which control then passes to a step 106 to select appropriate subject matter information and/or healthcare information based, at least in part, on the user's subject matter literacy and/or healthcare literacy, after which control then passes to a step 108 to provide the appropriate level of subject matter information and/or healthcare information to the user, after which the method 100 then ends in a step 110.

Referring again to FIG. 1, the system 10 can also be provided with a monitoring device 26 in which additional data can be gathered from the user. In the healthcare embodiment, for example, such monitoring devices can capture psychological and/or physiological data about users, such as at least one or more of their electrocardiograph (“ECG”) data, blood oxygen saturation data, respiration data, blood glucose data, blood pressure data, lung function data, SpO₂ saturation data, temperature data, weight data, fat analysis data, heart rate data, patient activity data, symptoms, and/or overall health data (e.g., using a self-assessment SF-36 Questionnaire, which can be used to gauge a user's overall health), etc. The monitoring device 26 can receive this additional data about the user from the user or another application, such as a personal health record (“PHR”) or electronic medical record (“EMR”) operable in connection with the system 10. This additional data about the user can include at least one or more of psychological data or physiological data about the user, and include at least one or more of an electrocardiograph (“ECG”) data, blood oxygen saturation data, respiration data, blood glucose data, blood pressure data, lung function data, SpO₂ saturation data, temperature data, weight data, fat analysis data, heart rate data, patient activity data, symptoms, and/or overall health data. Accordingly, the healthcare information provided to the user can also be based, at least in part, on the additional data, and the memory 16 can store additional information about the user and/or a user's system session, as needed and/or desired.

In accordance with the foregoing, a technical effect is that customized subject matter information is provided to users based, at least in part, on the users' subject matter literacy. Another technical effect is that customized healthcare information is provided to users based, at least in part, on the users' healthcare literacy. Accordingly, subject matter information and/or healthcare information can be provided to user to respectively enhance subject matter communications and/or healthcare communications.

It should be readily apparent that this specification describes illustrative, exemplary, representative, and non-limiting embodiments of the inventive arrangements. Accordingly, the scope of the inventive arrangements are not limited to any of these embodiments. Rather, various details and features of the embodiments were disclosed as required. Thus, many changes and modifications—as readily apparent to those skilled in these arts—are within the scope of the inventive arrangements without departing from the spirit hereof, and the inventive arrangements are inclusive thereof. Accordingly, to apprise the public of the scope and spirit of the inventive arrangements, the following claims are made:

What is claimed is:

1. A system for providing healthcare information, comprising:
a user interface configurable to interact with a user;
a processor configurable to interact with said user through said user interface to determine said user's healthcare literacy; and
a memory configurable to contain one or more data stores for providing healthcare information to said user from said data stores based, at least in part, on said user's healthcare literacy.

2. The system of claim 1, wherein said processor determines said user's healthcare literacy by administering a healthcare literacy test to said user.

3. The system of claim 2, wherein said processor administers said healthcare literacy test to said user by providing at least one or more of a paper document, tablet input, user kiosk, interactive telephonic connection, computer session, or computer internet connection to said user.

4. The system of claim 1, further comprising:
a monitoring device configurable to receive additional data about said user.

5. The system of claim 4, wherein said additional data includes at least one or more of psychological or physiological data about said user.

6. The system of claim 5, wherein said data includes at least one or more of an electrocardiograph (“ECG”) data, blood oxygen saturation data, respiration data, blood glucose data, blood pressure data, lung function data, SpO₂ saturation data, temperature data, weight data, fat analysis data, heart rate data, patient activity data, symptoms, or overall health data.

7. The system of claim 4, wherein said monitoring device receives said additional data from said user.

8. The system of claim 4, wherein said information is based, at least in part, on said additional data.

9. A method for providing healthcare information, comprising:
determining a user's healthcare literacy;
selecting healthcare information from one or more data stores based, at least in part, on said user's healthcare literacy; and
providing said healthcare information to said user from said data stores.

10. The method of claim 9, wherein said determining comprises administering a healthcare literacy test to said user.

11. The method of claim 10, wherein said healthcare test is provided to said user by providing at least one or more of a paper document, tablet input, user kiosk, interactive telephonic connection, computer session, or computer internet connection to said user.

12. The method of claim 9, further comprising:
receiving additional data about said user.

13. The method of claim 12, wherein said additional data includes at least one or more of psychological or physiological data about said user.

14. The method of claim 13, wherein said data includes at least one or more of an electrocardiograph (“ECG”) data, blood oxygen saturation data, respiration data, blood glucose data, blood pressure data, lung function data, SpO₂ saturation data, temperature data, weight data, fat analysis data, heart rate data, patient activity data, symptoms, or overall health data.

15. The method of claim 12, wherein said additional data is received from said user.

16. The method of claim 12, wherein said information is based, at least in part, on said additional data.

17. A machine-readable storage medium containing machine-executable code for instructing a system to operate as follows:
determine a user's healthcare literacy;
select healthcare information from one or more data stores based, at least in part, on said user's healthcare literacy; and
provide said healthcare information to said user from said data stores.

18. Machine-executable code stored on a machine-readable storage medium, comprising:
code for determining a user's healthcare literacy;
code for selecting healthcare information from one or more data stores based, at least in part, on said user's healthcare literacy; and
code for providing said healthcare information to said user from said data stores.

19. A system for providing subject matter information, comprising:
a user interface configurable to interact with a user;
a processor configurable to interact with said user through said user interface to determine said user's subject matter literacy; and
a memory configurable to contain one or more data stores for providing subject matter information to said user from said data stores based, at least in part, on said user's subject matter literacy.

20. A method for providing subject matter information, comprising:
determining a user's subject matter literacy;
selecting subject matter information from one or more data stores based, at least in part, on said user's subject matter literacy; and
providing said subject matter information to said user from said data stores.

21. A machine-readable storage medium containing machine-executable code for instructing a system to operate as follows:
determine a user's subject matter literacy;
select subject matter information from one or more data stores based, at least in part, on said user's subject matter literacy; and
provide said subject matter information to said user from said data stores.

22. Machine-executable code stored on a machine-readable storage medium, comprising:
code for determining a user's subject matter literacy;
code for selecting subject matter information from one or more data stores based, at least in part, on said user's subject matter literacy; and
code for providing said subject matter information to said user from said data stores.
